(19) United States
(12) Patent Application Publication
(10) Pub. No.: US 2026/0110854 A1
(43) Pub. Date: Apr. 23, 2026

(54) MALE/FEMALE COMPATIBLE MULTI-FIBER ADAPTER

(71) Applicant: NINGBO LITAS OPTICAL TECHNOLOGIES CO., LTD., Ningbo (CN)

(72) Inventors: Benjamin Bin JIAN, Ningbo (CN); Yanhe XIAO, Ningbo (CN); Zunzhu LIU, Ningbo (CN)

(21) Appl. No.: 19/168,789

(22) PCT Filed: Feb. 2, 2024
(86) PCT No.: PCT/CN2024/075508

§ 371 Date: Sep. 24, 2025

(30) Foreign Application Priority Data
Mar. 31, 2023 (CN) 202310353747.4

(51) Int. Cl. G02B 6/38

(52) U.S. Cl. CPC G02B 6/3825; G02B 6/3831; G02B 6/3882

(57) ABSTRACT

A male/female compatible multi-fiber adapter for connecting a multi-fiber ferrule into a ferrule in an optical fiber connector, comprising an adapter housing provided with a positioning mechanism for placing the multi-fiber ferrule. The positioning mechanism has a first opening for inserting the multi-fiber ferrule; and a second opening for receiving the optical fiber connector in a pluggable manner, the two openings combined connect the multi-fiber ferrule and the ferrule in the optical fiber connector. The first opening, movably provided on the adapter housing, is provided with a limiting latch for position-limiting the multi-fiber ferrule along the axial direction of optical fibers. Position-limiting and release of the multi-fiber ferrule is achieved by the movement of the limiting latch, facilitating the dismounting of the multi-fiber ferrule; the limiting latch has a movable mounting relationship with the adapter housing, and will not be lost, thereby ensuring the stability of position limiting.

### TECHNICAL FIELD

The present invention relates to the field of connector technology, especially relating to a male/female compatible multi-fiber adapter.

### BACKGROUND

Currently, the vast majority of multi-fiber connectors on the market are MPO fiber optic connectors, which are based on a precision component such as the MT ferrule and surrounded by various mating parts. MPO fiber optic connectors are particularly suitable for applications involving thick optical cables with tensile strength requirements.

The MT ferrule has the superiorities of high connection density and compact size, enabling it to be used independently in some high-density scenarios. In some application cases, MPO fiber optic connectors are required to be compatible with MT ferrules, thus a precise MT-to-MPO adapter is necessary.

U.S. Patent Application with publication No. US2020/0200977A1 have disclosed an MT-to-MPO adapter, which has upper and lower plastic arms for clamping the MT ferrule. The disassembly of such a complex adapter requires the use of additionally tool, resulting in each disassembly process challenging and time-consuming. In addition, this MT-to-MPO adapter only mentions female MT ferrules, but does not reference to male MT ferrules.

The Chinese invention patent with publication No. CN109143482A have disclosed an optical fiber cable assembly and its adapter assembly, which is applied in MT-to-MPO optical paths. The cover plate and base of adapter are fixedly connected by screws, thereby securing the two ferrules within the housing. The use of screw fasteners, along with the cooperation of cover plate and base plate to realize positioning, has led to the adapter being difficult to disassembly and resulting in cumbersome and inefficient procedures. To solve the above problems, the Chinese utility model patent with Patent No. 201922061076.6 have disclosed a conveniently detachable MT-to-MPO adapter, which uses a positioning baffle to fix the MT ferrule. Such a structure exhibited the individual positioning baffle and adapter housing, which means a risk of the positioning baffle being lost. In addition, this MT-to-MPO adapter patent also only mentions female MT ferrules, but does not reference to male MT ferrules.

### SUMMARY

The technical problem to be solved by the present invention is to provide an integral-type MT-to-MPO fiber optic adapter that features a simple structure, convenient assembly and disassembly, and reliable limiting. The integrated adapter is compatible with both male and female ferrules, and exhibits equally excellent performance whether male or female MT ferrules were being inserted and used.

The technical solution adopted by the present invention to solve the above-mentioned technical problems is as follows:

A male/female compatible multi-fiber adapter for mating a multi-fiber ferrule with another ferrule in an optical fiber connector, comprising:
an adapter housing, wherein said adapter housing is provided with a positioning mechanism for placing said multi-fiber ferrule, and said positioning mechanism is provided with a first opening for inserting said multi-fiber ferrule;
a second opening for pluggably receiving said fiber optic connector, said first opening and said second opening are used for mating said multi-fiber ferrule with said ferrule in said fiber optic connector;

Wherein said first opening is provided with a limiting latch for limiting said multi-fiber ferrule along the fiber optic axial direction, said limiting latch is movably arranged on said adapter housing, and said limiting latch includes a first limiting baffle; when said first limiting baffle is positioned outwardly behind said first opening, said limiting latch serves to limit said multi-fiber ferrule axially.

Said limiting latch is pivotally connected to said adapter housing.

Said limiting latch comprises two oppositely arranged swinging arms;

Said first limiting baffle is arranged between said two swinging arms;

The two swinging arms are respectively pivotally connected to two opposite side surfaces of said adapter housing;

When said multi-fiber ferrule is disposed on said adapter housing, said first limiting baffle can axially limit said multi-fiber ferrule to prevent it from disengaging from said adapter housing.

A locking mechanism is disposed between said limiting latch and said adapter housing; said locking mechanism includes two locking protrusions respectively protruding from the side portions of said adapter housing, and locking recesses provided on said swinging arms; when said limiting latch is in the locked position, said locking protrusions are disposed in corresponding locking recesses.

Said limiting latch is arranged to be movable up and down on said adapter housing.

Said limiting latch comprises two oppositely arranged sliding arms;

Said first limiting baffle is arranged between said two sliding arms;

Said two sliding arms are respectively arranged to be slidable up and down on two opposite side surfaces of said adapter housing;

When said multi-fiber ferrule is disposed on said adapter housing, said first limiting baffle can axially limit said multi-fiber ferrule to prevent it from disengaging from said adapter housing.

A locking mechanism is disposed between said limiting latch and said adapter housing; two opposite side surfaces of said adapter housing are respectively provided with sliding limiting grooves for said sliding arms to slide up and down; said locking mechanism includes two limiting protrusions respectively protrudingly disposed in said sliding limiting grooves; convex buckles and limiting hooks are protrudingly disposed on the inner end surfaces of said sliding arms; said limiting hooks are disposed at intervals below said convex buckles; when said limiting latch is in said locked position, said convex buckles are hooked under the corresponding limiting protrusions.

Said limiting latch further includes a second limiting baffle, and said first limiting baffle and the said second limiting baffle have a displacement in the axial direction.

Further comprises two guide pins and a guide pin bracket; one end of guide pins extending outwards from said multi-fiber ferrule, and the other end of guide pins is disposed on said guide pin bracket.

Said guide pin bracket has two spaced-apart mounting portions for mounting said guide pins; the lower ends of the two mounting portions are connected by a connecting portion; an upper opening is formed between said two mounting portions and said connecting portion, and the fibers of said multi-fiber ferrule are delivered through said upper opening;

Said first limiting baffle extends from said upper opening to limit said multi-fiber ferrule, and said second limiting baffle limits said guide pin bracket.

Compared with the prior art, the present invention has the superiorities that: the axial limitation of the multi-fiber ferrule on the adapter housing is realized through a limiting latch movably mounted on the adapter housing. The limiting and releasing of the multi-fiber ferrule can be realized by the movement of the limiting latch on the adapter housing, facilitating the assembly and disassembly of the multi-fiber ferrule. The limiting latch and the adapter housing are in a movably mounted relationship, which can prevents the limiting latch from falling off or even lost, and ensure the effective stability of limiting.

### BRIEF DESCRIPTION OF THE DRAWINGS

FIG. 1 is a schematic perspective view of all components of the male/female compatible MT-to-MPO fiber optic adapter in Embodiment 1 of the present invention;

FIG. 2(A) is a perspective view of the adapter mainbody 1 in Embodiment 1;

FIG. 2(B) is a perspective sectional view of the adapter mainbody 1 in Embodiment 1.

FIG. 3 is a perspective view of the limiting latch 2 in Embodiment 1;

FIG. 4 is a perspective view of the limiting latch 2 and the adapter mainbody 1 after assembly in Embodiment 1, with the limiting latch 2 in an open state;

FIG. 5(A) is a perspective view of the female MT ferrule 5 inserted into the adapter mainbody 1 in Embodiment 1, with the limiting latch 2 in an open state;

FIG. 5(B) is a perspective view of the female MT ferrule 5 inserted into the adapter mainbody 1 in Embodiment 1, with the limiting latch 2 in a locked state;

FIG. 6(A) is a perspective view of the assembly of guide pin bracket and guide pins;

FIG. 6(B) is a perspective view of the male ferrule not installed into the adapter mainbody in Embodiment 1;

FIG. 7(A) is a perspective view of the male MT ferrule inserted into the adapter mainbody 1 in Embodiment 1, with the limiting latch 2 in an open state;

FIG. 7(B) is a perspective view of the male MT ferrule inserted into the adapter mainbody 1 in Embodiment 1, with the limiting latch 2 in a locked state;

FIG. 8 is a sectional view of the male MT ferrule and the adapter mainbody 1 after assembly in Embodiment 1;

FIG. 9 is a perspective view of the adapter mainbody 101 in Embodiment 2.

FIG. 10 is a perspective view of the limiting latch 102 in Embodiment 2.

FIG. 11 is a perspective view of the adapter after the limiting latch 102 and the adapter mainbody 101 are assembled in Embodiment 2, with the limiting latch 102 in an open state.

FIG. 12(A) shows that in Embodiment 2, the male ferrule is inserted into the adapter mainbody 101, with the limiting latch 102 in an open state.

FIG. 12(B) shows that in Embodiment 2, the male ferrule is inserted into the adapter mainbody 101, with the limiting latch 102 in a locked state.

### DETAILED DESCRIPTION

The application will be described in detail below. Although specific embodiments of the present application are shown, it should be understood that the present application may be implemented in various forms and should not be limited by the embodiments set forth herein. On the contrary, these embodiments are provided to enable a more thorough understanding of the present application and to fully convey the scope of the present application to those skilled in the art.

It should be noted that the terms “comprise” or “include” mentioned throughout the specification and claims are open-ended terms, and thus should be interpreted as “including but not limited to”. The subsequent description in the specification sets forth preferred modes for implementing the present application; however, such description is for the purpose of the general principles of the specification and is not intended to limit the scope of the present application. The protection scope of the present application shall be subject to what is defined by the appended claims.

### Embodiment 1

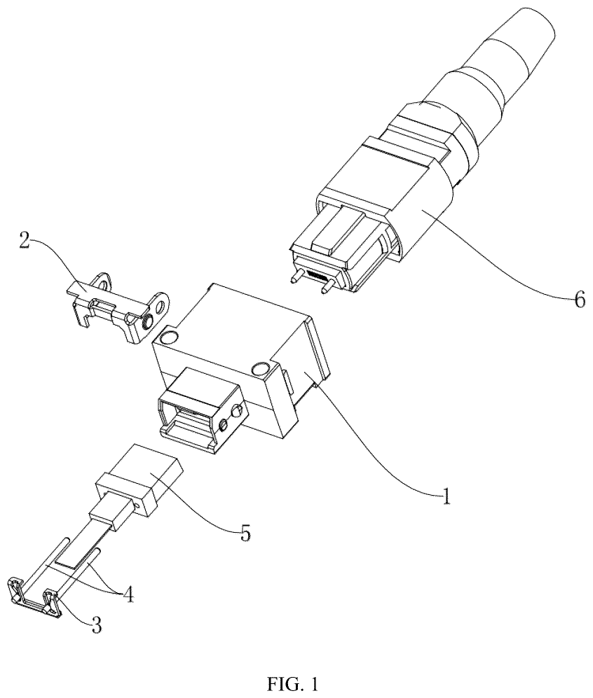

FIG. 1 is a schematic perspective view of all components of the male/female compatible MT-to-MPO optical fiber adapter of the present invention. It includes an adapter mainbody 1, a limiting latch 2, a guide pin bracket 3, and a guide pin 4. Both ends of this adapter receive an MT ferrule 5 and an MPO connector 6 respectively.

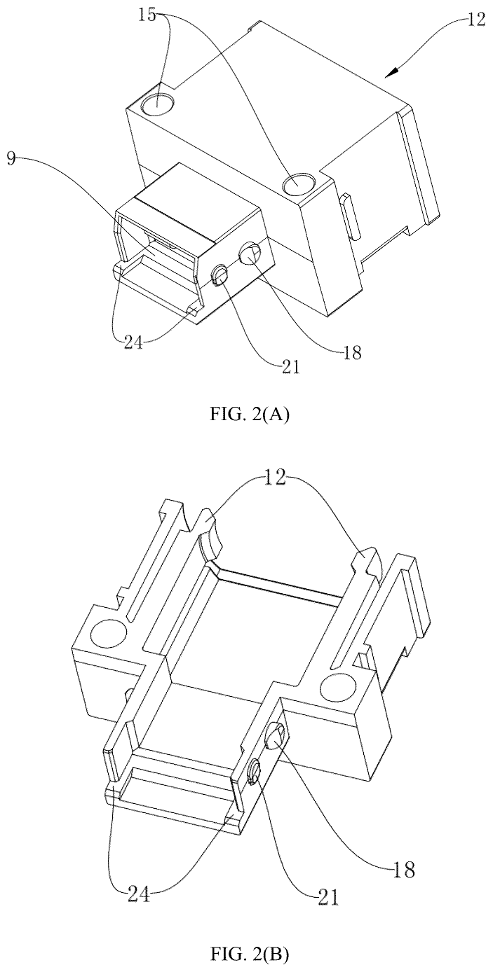

FIG. 2(A) is a perspective view of the adapter mainbody 1, and FIG. 2(B) is a perspective sectional view of the adapter mainbody 1.

The adapter mainbody 1 has a first opening 9, which is an MT socket, and a second opening 12, which is an MPO socket. The adapter mainbody 1 is provided with two through holes 15, facilitating fixation to the machine base plate with screws.

The MT socket end is provided with a rotating shaft 18, locking protrusions 21, and foolproof protrusions 24.

The MT socket end is provided with a channel-shaped position fixing mechanism, allowing the MT ferrule 5 to be inserted and limiting the MT ferrule 5 from the four sides of the ferrule. The internal dimensions of the position fixing mechanism and the MT ferrule 5 are in loose fit, which not only provides sufficient ferrule alignment accuracy, but also ensures free insertion and removal of the ferrule.

The internal structure of the MPO socket end is in the prior art.

Preferably, the adapter mainbody 1 is made of plastic and manufactured through an injection molding process.

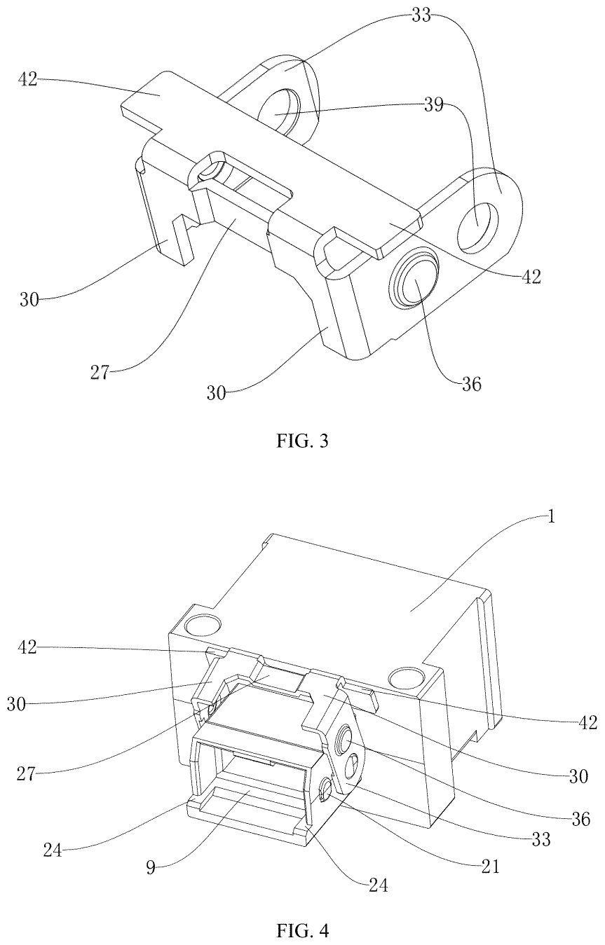

FIG. 3 is a perspective view of the limiting latch 2.

The limiting latch 2 includes a first limiting baffle 27 and a second limiting baffle 30, there is a displacement between the two limiting baffles in the axial direction of the fiber optic. Preferably, the displacement is 0.35 mm.

Two oppositely arranged swinging arms 33, two locking recesses 36, two rotating holes 39, and latch handle 42.

Preferably, the limiting latch 2 is manufactured by stainless steel with a thickness of 0.4 mm or more. It is manufactured via a stamping process, which features robust material and low production cost.

FIG. 4 is a perspective view of the adapter after the limiting latch 2 and the adapter mainbody 1 are assembled, with the limiting latch 2 in an open state.

The two swinging arms 33 are respectively disposed on two opposite side surfaces of the adapter mainbody 1. The rotating holes 39 of the limiting latch 2 are pivotally connected to the rotating shafts 18 of the adapter mainbody 1. This adapter has two states: an open state and a locked state.

The Adapter is Used for Mating with a Female MT Ferrule

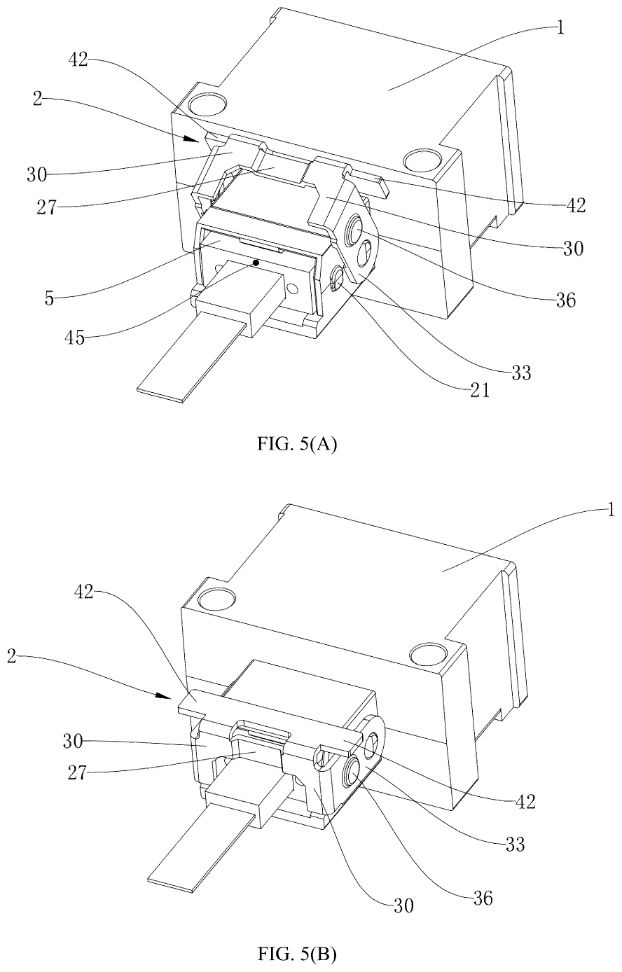

Insert the MT ferrule 5 into the MT socket of the adapter mainbody 1 until it stops. FIG. 5(A) is a perspective view of the female MT ferrule 5 after being inserted into the adapter mainbody 1, with the limiting latch 2 in an open state at this time.

After the MT ferrule 5 is inserted, toggle the latch handle 42 until the limiting latch 2 reaches the locked state at the lowest point, as shown in FIG. 5(B), which is a perspective view of the female MT ferrule 5 after being inserted into the adapter mainbody 1. At this time, the limiting latch 2 is in a locked state, and the limiting latch 2 and the adapter mainbody 1 are locked via the two locking recesses 36 and the corresponding locking protrusions 21.

In this state, the rear surface 45 of the MT ferrule 5, near the indicated point in the figure, is partially restrained by the first limiting baffle 27 of the limiting latch 2, preventing it from withdrawing from the adapter mainbody 1.

If it is required to remove the MT ferrule 5 again, only toggle the latch handle 42 upward until the limiting latch 2 reaches the open state.

The Adapter is Used for Mating with Male MT Ferrules

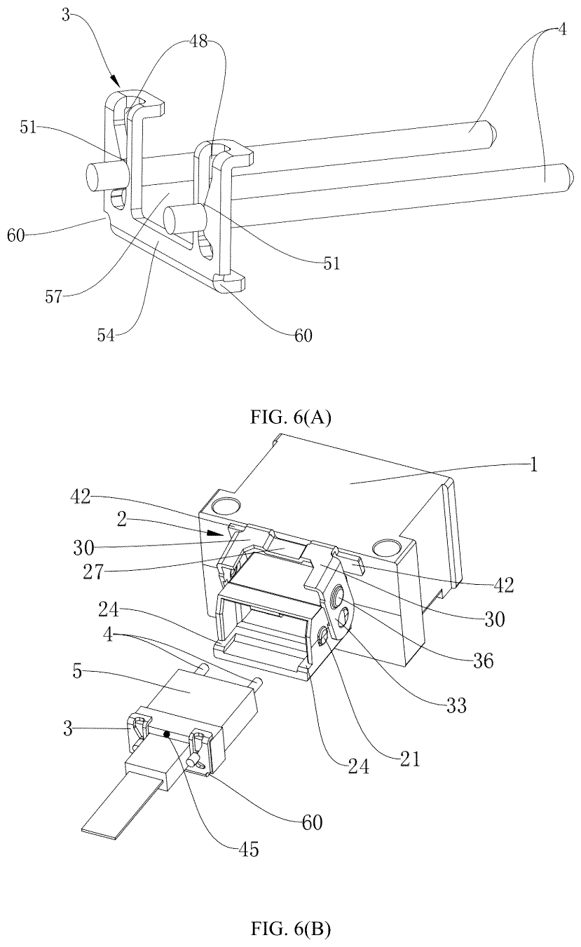

The adapter of the present invention is compatible with both male and female ferrules. When used as an adapter for male ferrules, it needs to be matched with a special guide pin assembly. FIG. 6(A) is an assembled perspective view of this special guide pin assembly, which includes two guide pins 4 and a guide pin bracket 3.

The guide pin bracket 3 is provided with two guide pin fixing chutes 48 and fixing grooves 51 that snap-fit to fix the guide pins 4. It has curved surfaces on both the upper and lower parts, securing the MT ferrule 5 from three sides, so the guide pin bracket 3 is not easily separated from the MT ferrule 5. Its lower part is provided with a continuous edge 54 with right angles, while the upper part is discontinuous, forming an upper opening 57. The fiber optic bundle of the MT ferrule 5 can be delivered to the central axis position of the adapter through the upper opening 57.

Since the assembly of the guide pin bracket 3 and the guide pins 4 is a separate component, sturdiness and resistance to deformation are important requirements. Ideally, the guide pin bracket 3 should be as thick as possible; however, from the perspective of processing costs, the preferred manufacturing process is stamping, and excessive thickness makes it difficult to form the guide pin fixing chutes 48. Therefore, the preferred material for the guide pin bracket 3 is stainless steel, with a thickness of 0.3 mm, and it is designed with a continuous edge 54 featuring right angles.

When the adapter is used for mating with a male MT ferrule, the two guide pins 4 on the guide pin bracket 3 pass through the two ferrule guide pin holes on the MT ferrule 5 to connect with the MT ferrule 5, as shown in FIG. 6(B).

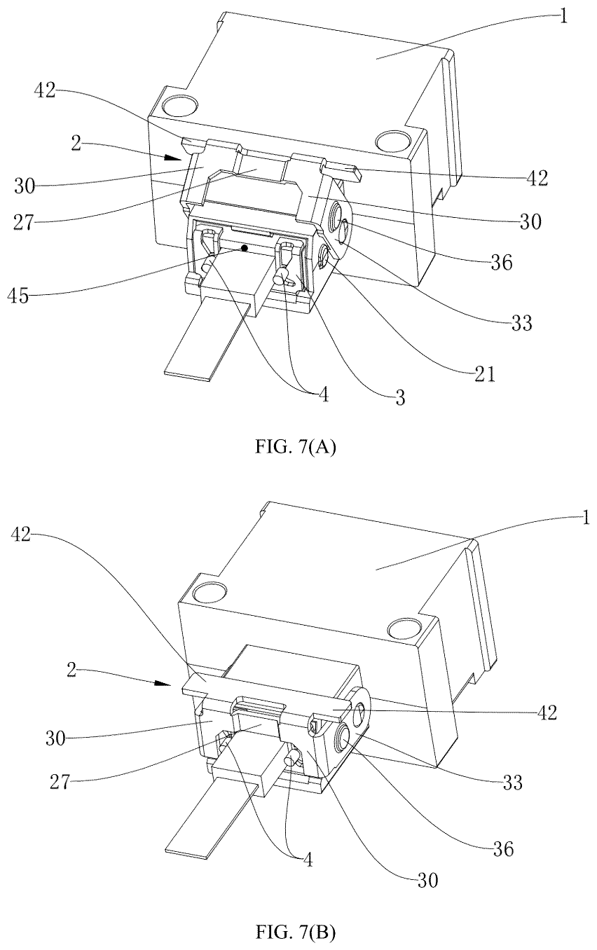

FIG. 7(A) shows the male ferrule inserted into the adapter mainbody 1, with the limiting latch 2 in an open state. The foolproof notch 60 on the guide pin bracket 3 is aligned with the foolproof protrusion 24 on the adapter mainbody 1, and the male MT ferrule is inserted into the MT socket of the adapter mainbody 1.

Note that in this state, the rear surface 45 of the MT ferrule 5 is not blocked by the guide pin bracket 3 only near the indicated point in the figure.

FIG. 7(B) shows the male ferrule inserted into the adapter mainbody 1, with the limiting latch 2 in a locked state. At this time, the first limiting baffle of the limiting latch 2 directly restrains the rear surface 45 of the ferrule, and at the same time, the second limiting baffle 30 of the limiting latch 2 restrains the guide pin bracket 3.

### Male/Female Compatibility

The fiber end facet contact surfaces of the MT ferrule coincide for both male and female MT ferrules. The optical performance of the adapter in the present invention is optimized for both male and female ferrules. This is a unique and significant superiority and feature of the present invention, and an unexpected result.

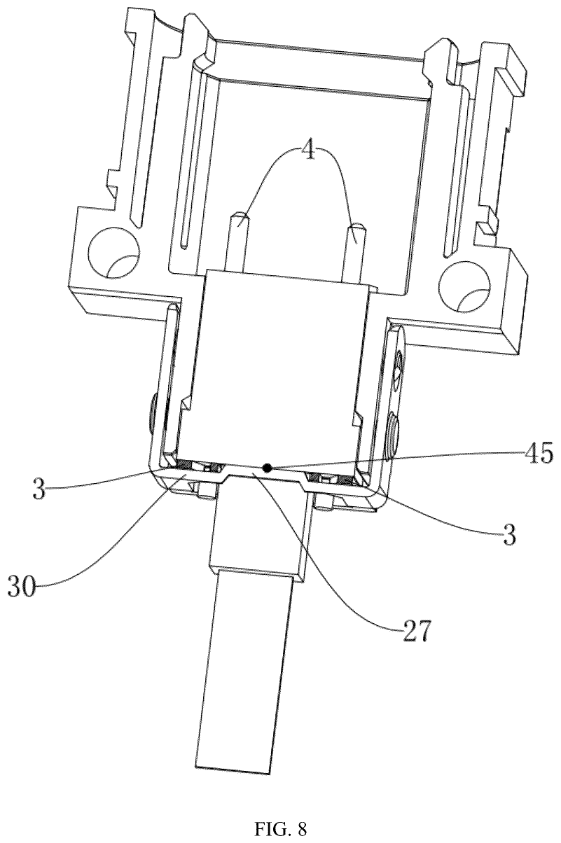

This feature is achieved through the special design of the guide pin bracket 3 and the limiting latch 2. FIG. 8 is a sectional view of the assembled male ferrule, which allows a clearer view of this special design. The first limiting baffle 27 of the limiting latch 2 directly restrains the rear surface 45 of the male ferrule, rather than through the guide pin bracket 3. Meanwhile, the second limiting baffle 30 of the limiting latch 2 restrains the guide pin bracket 3.

### The Superiorities of Embodiment

The adapter of this embodiment has the following superiorities:
1) No tools are required; only by toggling the limiting latch 2 can quick connection of male and female MT ferrules be achieved, making it easy to use.
2) The limiting latch 2 is compact, and the entire adapter is also compact.
3) The special design of the limiting latch 2 allows it to directly limit the rear surface 45 of the ferrule, enabling the function of male/female compatibility. With the provided special guide pin bracket 3, a female MT ferrule 5 can be quickly converted into a male MT ferrule.

### Embodiment 2

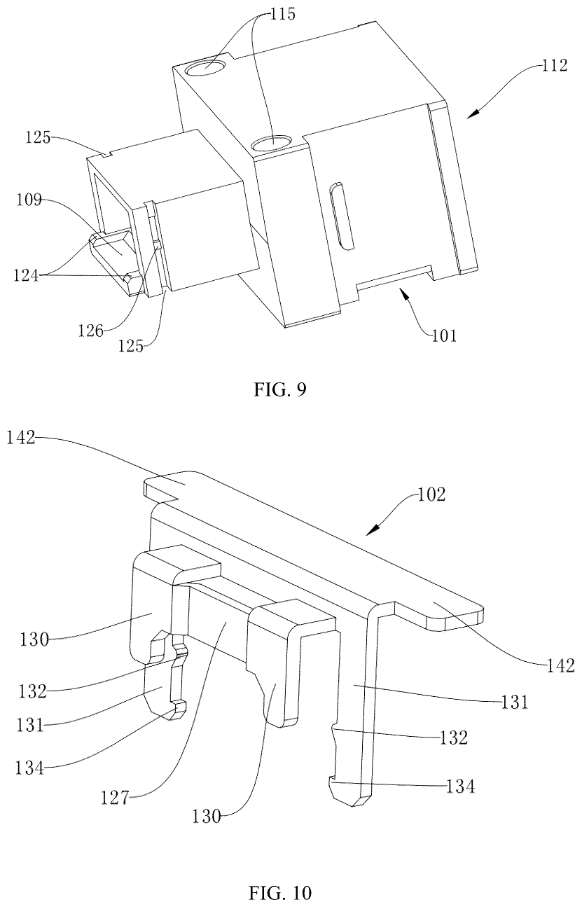

FIG. 9 is a perspective view of the adapter mainbody 101.

The adapter mainbody 101 has a first opening 109, which is an MT socket, and a second opening 112, which is an MPO socket. The adapter mainbody 101 is provided with two through holes 115, facilitating fixation to the machine base plate with screws.

At the MT socket end, there are foolproof protrusions 124, sliding limiting grooves 125, and limiting protrusions 126.

The MT socket end is provided with a channel-shaped position fixing mechanism, allowing the MT ferrule 5 to be inserted and limiting the MT ferrule 5 from the four sides of the ferrule. The internal dimensions of the position fixing mechanism and the MT ferrule 5 are in loose fit, which not only provides sufficient ferrule alignment accuracy but also ensures free insertion and removal of the ferrule.

The internal structure of the MPO socket end is in the prior art.

Preferably, the adapter mainbody 101 is made of plastic and manufactured through an injection molding process.

FIG. 10 is a perspective view of the limiting latch 102.

The limiting latch 102 includes a first limiting baffle 127 and a second limiting baffle 130, there is a displacement between the two limiting baffles in the axial direction of the fiber optic; preferably, the distance is 0.35 mm. It also includes two parallel sliding arms 131, two convex buckles 132, two limiting hooks 134, and a latch handle 142.

Preferably, the limiting latch 102 is manufactured by stainless steel with a thickness of 0.4 mm or more. It is manufactured via a stamping process, featuring robust material and low production cost.

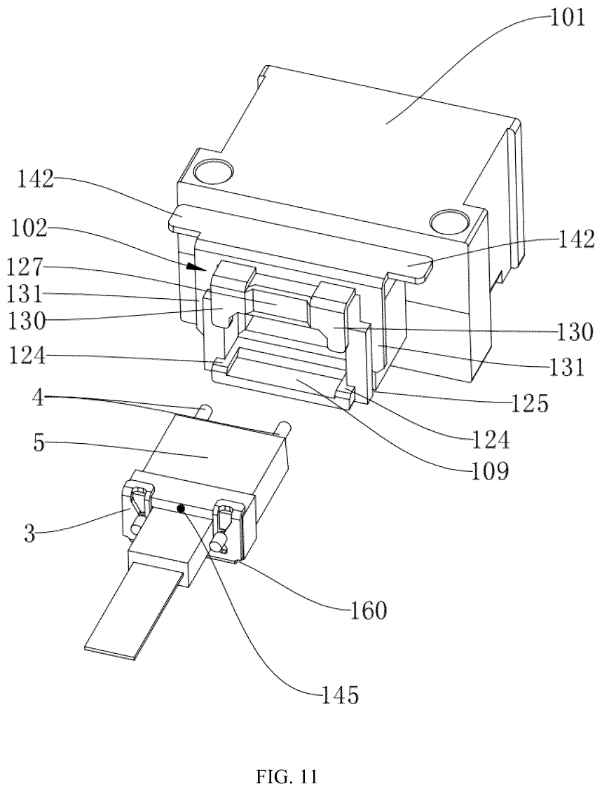

FIG. 11 is a perspective view of the adapter after the limiting latch 102 and the adapter mainbody 101 are assembled, with the limiting latch 102 in an open state. Also shown are the MT ferrule 5 and the guide pin bracket 3, which are used for the male MT ferrule.

When the limiting latch 102 and the adapter mainbody 101 are assembled, the sliding arms 131 are inserted from above along the sliding limiting grooves 125 of the adapter mainbody 101. After the two limiting hooks 134 pass over the limiting protrusions 126, they restrict the limiting latch 102 from coming out of the sliding limiting grooves 125, but the limiting latch 102 can still slide up and down along the sliding limiting grooves 125.

The adapter of this embodiment has two states: the upper position is the open state, allowing the MT ferrule 5 to be inserted; the lower position is the locked state, limiting the MT ferrule 5 from being pulled out.

The Adapter Used for Mating with Male MT Ferrules

The adapter of the present invention is compatible with both male and female ferrules. When used as an adapter for male ferrules, it needs to be matched with the aforementioned special guide pin assembly (FIG. 6B). The two guide pins 4 on the guide pin bracket 3 pass through the two ferrule guide pin holes on the MT ferrule 5, as shown in FIG. 11.

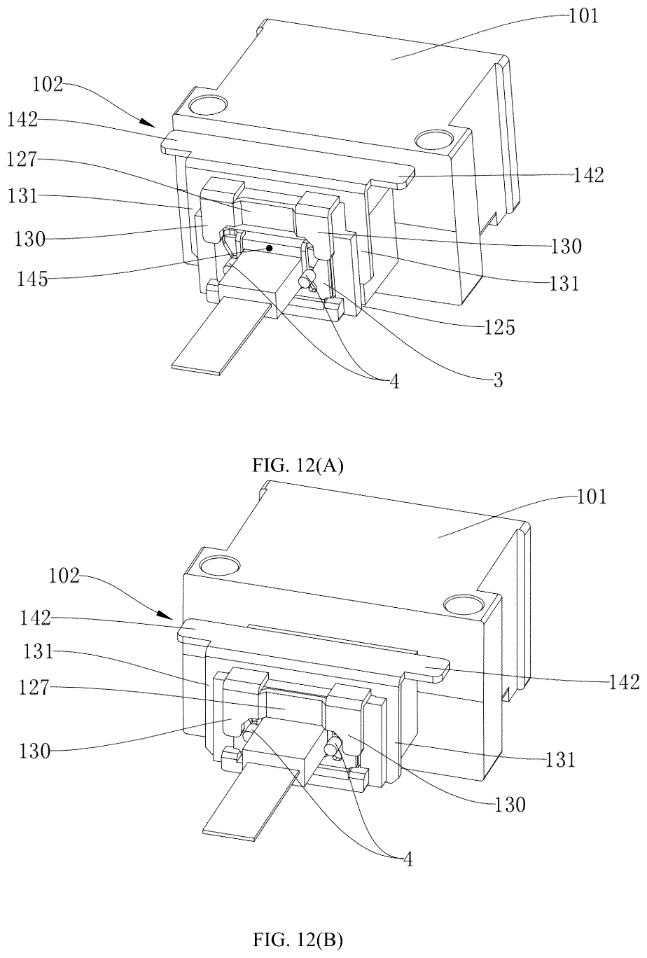

FIG. 12(A) shows the male ferrule inserted into the adapter mainbody 101, with the limiting latch 102 in an open state. The foolproof notch 160 on the guide pin bracket 3 is aligned with the foolproof protrusion 124 on the adapter mainbody 101, and the male MT ferrule is inserted into the MT socket of the adapter mainbody 101.

Note that in this state, the rear surface 145 of the MT ferrule 5 is not blocked by the guide pin bracket 3 only near the indicated point in the figure.

FIG. 12(B) shows the male ferrule inserted into the adapter mainbody 101, with the limiting latch 102 in a locked state. At this time, the first limiting baffle 127 of the limiting latch 102 directly restrains the rear surface 145 of the ferrule 5, and at the same time, the second limiting baffle 130 of the limiting latch 102 restrains the guide pin bracket 3.

The Adapter Used for Mating with the Female MT Ferrule

When the adapter is used for mating with a female MT ferrule, except that there are no guide pins 4 and guide pin brackets 3, the other operations are the same as those for the male ferrule. Details are not repeated here.

In this state, the rear surface 145 of the MT ferrule 5, near the indicated point in the figure, is partially limited by the first limiting baffle 127 of the limiting latch 102 and cannot withdraw from the adapter mainbody 101.

This specific embodiment is merely an explanation of the present application, not a limitation thereof. After reading this specification, those skilled in the art may make modifications to this embodiment without creative contributions as needed; however, as long as they fall within the scope of the claims of the present application, they shall be protected by patent law.

1. A male/female compatible multi-fiber adapter for mating a multi-fiber ferrule with another ferrule in an optical fiber connector, comprising:
an adapter housing, wherein said adapter housing is provided with a positioning mechanism for placing said multi-fiber ferrule, and said positioning mechanism is provided with a first opening for inserting said multi-fiber ferrule;
a second opening for pluggably receiving said fiber optic connector, said first opening and said second opening are used for mating said multi-fiber ferrule with said ferrule in said fiber optic connector;
wherein said first opening is provided with a limiting latch for limiting said multi-fiber ferrule along the fiber optic axial direction, said limiting latch is movably arranged on said adapter housing, and said limiting latch includes a first limiting baffle; when said first limiting baffle is positioned outwardly behind said first opening, said limiting latch serves to limit said multi-fiber ferrule axially;
wherein said limiting latch further includes a second limiting baffle, wherein said first limiting baffle and said second limiting baffle have a displacement in an axial direction, and said second limiting baffle limits said guide pin bracket.

2. The male/female compatible multi-fiber adapter according to claim 1, wherein said limiting latch is pivotally connected to said adapter housing.

3. The male/female compatible multi-fiber adapter according to claim 2, wherein
said limiting latch comprises two oppositely arranged swinging arms;
said first limiting baffle is arranged between said two swinging arms;
said two swinging arms are respectively pivotally connected to two opposite side surfaces of said adapter housing;
when said multi-fiber ferrule is disposed on said adapter housing, said first limiting baffle can axially limit said multi-fiber ferrule to prevent it from disengaging from said adapter housing.

4. The male/female compatible multi-fiber adapter according to claim 3, wherein a locking mechanism is disposed between said limiting latch and said adapter housing; said locking mechanism includes two locking protrusions respectively protruding from the side portions of said adapter housing, and locking recesses provided on said swinging arms; when said limiting latch is in the locked position, said locking protrusions are disposed in corresponding locking recesses.

5. The male/female compatible multi-fiber adapter according to claim 1, wherein said limiting latch is arranged to be movable up and down on said adapter housing.

6. The male/female compatible multi-fiber adapter according to claim 5, wherein said limiting latch comprises two oppositely arranged sliding arms;
said first limiting baffle is arranged between said two sliding arms;
said two sliding arms are respectively arranged to be slidable up and down on two opposite side surfaces of said adapter housing;
when said multi-fiber ferrule is disposed on said adapter housing, said first limiting baffle can axially limit said multi-fiber ferrule to prevent it from disengaging from said adapter housing.

7. The male/female compatible multi-fiber adapter according to claim 6, wherein a locking mechanism is disposed between said limiting latch and said adapter housing; two opposite side surfaces of said adapter housing are respectively provided with sliding limiting grooves for said sliding arms to slide up and down; said locking mechanism includes two limiting protrusions respectively protrudingly disposed in said sliding limiting grooves; convex buckles and limiting hooks are protrudingly disposed on the inner end surfaces of said sliding arms; said limiting hooks are disposed at intervals below said convex buckles; when said limiting latch is in said locked position, said convex buckles are hooked under the corresponding limiting protrusions.

8. (canceled)

9. The male/female compatible multi-fiber adapter according to claim 1, further comprising two guide pins and a guide pin bracket; one ends of said guide pins extend outwards from said multi-fiber ferrule, and the other ends of said guide pins is disposed on said guide pin bracket.

10. The male/female compatible multi-fiber adapter according to claim 9, wherein said guide pin bracket has two spaced-apart mounting portions for mounting said guide pins; the lower ends of said two mounting portions are connected by a connecting portion; an upper opening is formed between said two mounting portions and said connecting portion, and the fibers of said multi-fiber ferrule are delivered through said upper opening;
said first limiting baffle extends from said upper opening to limit said multi-fiber ferrule.
